(19) United States
(12) Patent Application Publication
(10) Pub. No.: US 2025/0216119 A1
(43) Pub. Date: Jul. 3, 2025

(54) VENTILATION TYPE SILENCER

(71) Applicant: FUJIFILM Corporation, Tokyo (JP)

(72) Inventors: Shogo YAMAZOE, Ashigarakami-gun (JP); Shun ISHIGE, Ashigarakami-gun (JP); Tomohiro TAKAHASHI, Ashigarakami-gun (JP); Yuichiro ITAI, Ashigarakami-gun (JP); Shinya HAKUTA, Ashigarakami-gun (JP)

(73) Assignee: FUJIFILM Corporation, Tokyo (JP)

(21) Appl. No.: 19/083,172

(22) Filed: Mar. 18, 2025

Related U.S. Application Data
(63) Continuation of application No. PCT/JP2023/034079, filed on Sep. 20, 2023.

(30) Foreign Application Priority Data
Oct. 20, 2022 (JP) 2022-168311

(51) Int. Cl. F24F 13/24; G10K 11/162

(52) U.S. Cl. CPC F24F 13/24; G10K 11/162; F24F 2013/242

(57) ABSTRACT

Provided is a ventilation type silencer that includes an expansion portion composed of a housing made of a resin and that can suppress occurrence of condensation in a rear space while suppressing an increase in size.

A ventilation type silencer includes an inlet side ventilation pipe, an expansion portion that communicates with the inlet side ventilation pipe and that has a cross-sectional area larger than a cross-sectional area of the inlet side ventilation pipe, an outlet side ventilation pipe that communicates with the expansion portion and that has a cross-sectional area smaller than the cross-sectional area of the expansion portion, a housing that constitutes the expansion portion and that is made of a resin, a flow passage wall that is disposed in the housing, that causes the inlet side ventilation pipe and the outlet side ventilation pipe to communicate with each other, and that is composed of a first portion of the housing and a porous sound absorbing material, a rear space that is positioned on an opposite side of a flow passage space in the flow passage wall with the porous sound absorbing material interposed therebetween and that is defined by the porous sound absorbing material and a second portion different from the first portion of the housing, and a heat transfer member that thermally connects the first portion and the second portion and that has thermal conductivity higher than thermal conductivity of the housing.

### CROSS-REFERENCE TO RELATED APPLICATIONS

This application is a Continuation of PCT International Application No. PCT/JP2023/034079 filed on Sep. 20, 2023, which claims priority under 35 U.S.C. § 119(a) to Japanese Patent Application No. 2022-168311 filed on Oct. 20, 2022. The above applications are hereby expressly incorporated by reference, in their entirety, into the present application.

### BACKGROUND OF THE INVENTION

### 1. Field of the Invention

The present invention relates to a ventilation type silencer.

### 2. Description of the Related Art

In general, a ventilation type silencer having an inlet side ventilation pipe, an expansion portion that communicates with the inlet side ventilation pipe and that has a cross-sectional area larger than that of the inlet side ventilation pipe, and an outlet side ventilation pipe that communicates with the expansion portion and that has a cross-sectional area smaller than that of the expansion portion is known.

As such a ventilation type silencer, a ventilation type silencer comprising a flow passage wall that is disposed in an expansion portion and that is formed of a porous sound absorbing material and a rear space that is positioned on a side opposite to a flow passage space in the flow passage wall with the flow passage wall interposed therebetween and that is defined by the flow passage wall and a housing of the expansion portion is known (for example, see JP1994-167982A (JP-H-6-167982A)).

### SUMMARY OF THE INVENTION

In such a ventilation type silencer, it is considered to make the housing of the expansion portion of a resin in order to reduce the weight and cost. However, according to the study by the present inventors, it is found that, in a case where the housing of the expansion portion is made of a resin, there is a possibility in which condensation occurs in the rear space in a case where the ventilation type silencer is installed outdoors and a high-temperature and high-humidity gas, which has a temperature higher than outdoors, is flowed into the flow passage space. This is because moisture that has been transmitted from the flow passage space to the rear space through microholes of the porous sound absorbing material comes into contact with a surface of the housing cooled by outside air on an inside.

As a method of suppressing the occurrence of condensation, a method of disposing a heat insulating member on an inside or an outside of the housing is considered. However, in a case where the heat insulating member is disposed on the inside of the housing, the rear space and the flow passage space are narrowed, and as a result, a silencing performance and air volume are reduced. Therefore, the heat insulating member is disposed on the outside of the housing, and accordingly, the device increases in size.

An object of the present invention is to solve the problems of the technique of the related art and to provide a ventilation type silencer that comprises an expansion portion composed of a housing made of a resin and that can suppress occurrence of condensation in a rear space while suppressing an increase in size.

In order to achieve the object, the present invention has the following configurations.

[1] A ventilation type silencer comprising:
an inlet side ventilation pipe;
an expansion portion that communicates with the inlet side ventilation pipe and that has a cross-sectional area larger than a cross-sectional area of the inlet side ventilation pipe;
an outlet side ventilation pipe that communicates with the expansion portion and that has a cross-sectional area smaller than the cross-sectional area of the expansion portion;
a housing that constitutes the expansion portion and that is made of a resin;
a flow passage wall that is disposed in the housing, that causes the inlet side ventilation pipe and the outlet side ventilation pipe to communicate with each other, and that is composed of a first portion of the housing and a porous sound absorbing material;
a rear space that is positioned on an opposite side of a flow passage space in the flow passage wall with the porous sound absorbing material interposed therebetween and that is defined by the porous sound absorbing material and a second portion different from the first portion of the housing; and
a heat transfer member that thermally connects the first portion and the second portion and that has thermal conductivity higher than thermal conductivity of the housing.

[2] The ventilation type silencer according to [1],
in which on an outside of the housing, the heat transfer member is disposed along the housing.

[3] The ventilation type silencer according to [1] or [2],
in which on an inside of the housing, the heat transfer member is disposed along the housing.

[4] The ventilation type silencer according to any one of [1] to [3], further comprising:
a heat insulating member that is disposed along an inside of the heat transfer member in the rear space.

[5] The ventilation type silencer according to any one of [1] to [4], further comprising:
a heat insulating member that is disposed along the heat transfer member on an opposite side of the housing with the heat transfer member interposed therebetween.

[6] The ventilation type silencer according to any one of [1] to [5],
in which a temperature of a gas flowing in the flow passage space is higher than a temperature outside the housing.

According to the present invention, the ventilation type silencer that comprises the expansion portion composed of the housing made of a resin and that can suppress occurrence of condensation in the rear space while suppressing an increase in size can be provided.

### BRIEF DESCRIPTION OF THE DRAWINGS

FIG. 1 is a perspective view conceptually showing an example of a ventilation type silencer according to an embodiment of the present invention.

FIG. 2 is a cross-sectional view taken along line A-A of FIG. 1.

FIG. 3 is a perspective view conceptually showing another example of the ventilation type silencer according to the embodiment of the present invention.

FIG. 4 is a cross-sectional view taken along line B-B of FIG. 3.

FIG. 5 is a perspective view conceptually showing still another example of the ventilation type silencer according to the embodiment of the present invention.

FIG. 6 is a cross-sectional view taken along line C-C of FIG. 5.

FIG. 7 is a perspective view conceptually showing still another example of the ventilation type silencer according to the embodiment of the present invention.

FIG. 8 is a cross-sectional view taken along line D-D of FIG. 7.

FIG. 9 is an exploded perspective view showing a ventilation type silencer according to a comparative example.

FIG. 10 is a view showing an image of a ventilation type silencer according to example 1, which is captured by a camera.

FIG. 11 is a view showing an image of the ventilation type silencer according to the comparative example, which is captured by an infrared thermography camera.

FIG. 12 is a view showing an image of the ventilation type silencer according to example 1, which is captured by the infrared thermography camera.

FIG. 13 is a view showing another image of the ventilation type silencer according to example 1, which is captured by the infrared thermography camera.

FIG. 14 is a view showing an image of a ventilation type silencer according to example 2, which is captured by the infrared thermography camera.

FIG. 15 is a graph comparing temperature distributions in a housing in examples 1 and 2.

FIG. 16 is a graph showing a relationship between a frequency and a transmission loss in example 1.

FIG. 17 is a graph showing a relationship between a frequency and noise released from the ventilation type silencer to the outside in comparative example and example 1.

### DESCRIPTION OF THE PREFERRED EMBODIMENTS

Hereinafter, a ventilation type silencer according to an embodiment of the present invention will be described in detail.

Description of configuration requirements written below is provided based on a representative embodiment of the present invention, but the present invention is not limited to such an embodiment.

In the present specification, numerical ranges represented by “to” include numerical values before and after “to” as a lower limit value and an upper limit value, respectively.

In addition, in the present specification, the terms “perpendicular” and “parallel” include a range of an error accepted in a technical field to which the present invention belongs. For example, the terms “perpendicular” and “parallel” mean a range less than +10° with respect to strict perpendicular or parallel, and an error with respect to strict perpendicular or parallel is preferably equal to or less than 5° and more preferably equal to or less than 3°.

In the present specification, the terms such as “identical” and “the same” may include a range of an error generally accepted in the technical field.

In addition, in the present specification, an arrangement direction of an inlet side ventilation pipe, an expansion portion, and an outlet side ventilation pipe is defined as an X-direction, a direction orthogonal to the X-direction is defined as a Y-direction, and a direction orthogonal to the X-direction and the Y-direction is defined as a Z-direction.

### <Ventilation Type Silencer>

A ventilation type silencer according to the embodiment of the present invention comprising:
an inlet side ventilation pipe;
an expansion portion that communicates with the inlet side ventilation pipe and that has a cross-sectional area larger than a cross-sectional area of the inlet side ventilation pipe;
an outlet side ventilation pipe that communicates with the expansion portion and that has a cross-sectional area smaller than the cross-sectional area of the expansion portion;
a housing that constitutes the expansion portion and that is made of a resin;
a flow passage wall that is disposed in the housing, that causes the inlet side ventilation pipe and the outlet side ventilation pipe to communicate with each other, and that is composed of a first portion of the housing and a porous sound absorbing material;
a rear space that is positioned on an opposite side of a flow passage space in the flow passage wall with the porous sound absorbing material interposed therebetween and that is defined by the porous sound absorbing material and a second portion different from the first portion of the housing; and
a heat transfer member that thermally connects the first portion and the second portion and that has thermal conductivity higher than thermal conductivity of the housing.

### EXAMPLE OF EMBODIMENT

A configuration of the ventilation type silencer according to the embodiment of the present invention will be described with reference to the drawings.

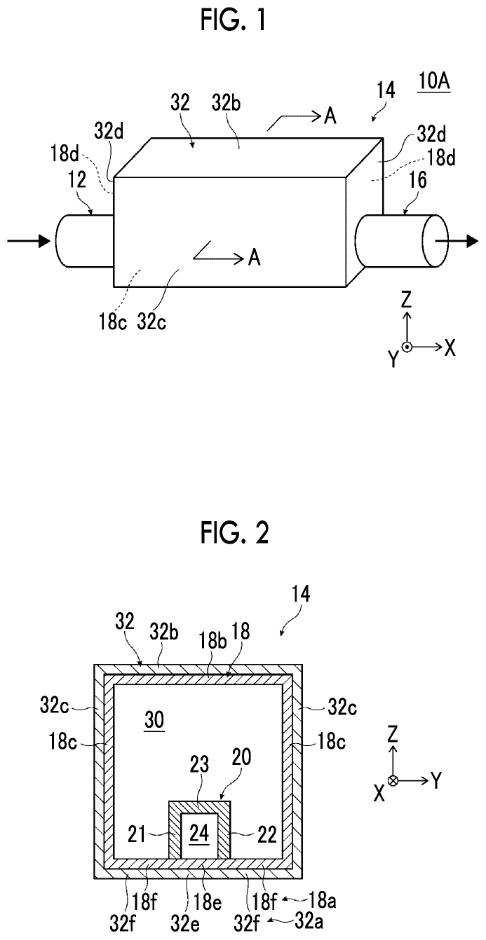

FIG. 1 is a perspective view conceptually showing an example of the ventilation type silencer according to the embodiment of the present invention. FIG. 2 is a cross-sectional view taken along line A-A of FIG. 1.

A ventilation type silencer 10A shown in FIG. 1 has a tubular inlet side ventilation pipe 12, an expansion portion 14 connected to one opening edge surface of the inlet side ventilation pipe 12, a tubular outlet side ventilation pipe 16 connected to an edge surface of the expansion portion 14 on a side opposite to the inlet side ventilation pipe 12, a rear space 30, a flow passage wall 20 disposed in a housing 18 of the expansion portion 14, and a heat transfer member 32 having thermal conductivity higher than that of the housing 18.

In the example shown in FIG. 1, a flow direction of a gas flowing in the expansion portion 14 is the same direction as the arrangement direction (X-direction).

A temperature and humidity of a gas flowing in the ventilation type silencer 10A vary depending on a usage form in which the ventilation type silencer 10A is used. In one example of this embodiment, as shown in FIG. 2, a temperature of the gas flowing in a flow passage space 24 in the expansion portion 14 is high compared to a temperature outside the ventilation type silencer 10A, that is, outside the housing 18 constituting the expansion portion 14. For example, a usage form in which the expansion portion 14 is disposed outdoors is assumed. The gas flowing in the flow passage space 24 is assumed to be high-temperature and high-humidity, and specifically, a temperature range is 20° C. to 80° C. and a humidity range is 50 to 95% RH.

### [Ventilation Pipe]

The inlet side ventilation pipe 12 is, as shown in FIG. 1, a tubular member, and a gas, which has flowed in from the one opening edge surface, is transported to the expansion portion 14, which is connected to the other opening edge surface, therethrough. The inlet side ventilation pipe 12 has a cross-sectional area smaller than that of the expansion portion 14.

The outlet side ventilation pipe 16 is, as shown in FIG. 1, a tubular member and communicates with the expansion portion 14, and a gas, which has flowed in from one opening edge surface connected to the expansion portion 14, is transported to the other opening edge surface therethrough. The outlet side ventilation pipe 16 has a cross-sectional area smaller than that of the expansion portion 14.

Cross-sectional shapes of the inlet side ventilation pipe 12 and the outlet side ventilation pipe 16 (hereinafter, also collectively referred to as a ventilation pipe) may be various shapes, such as a circular shape, a rectangular shape, and a triangular shape. In addition, the cross-sectional shape of the ventilation pipe may not be constant in an axial direction of a central axis of the ventilation pipe. For example, a diameter of the ventilation pipe may be changed in the axial direction.

The inlet side ventilation pipe 12 and the outlet side ventilation pipe 16 may have the same cross-sectional shape and cross-sectional area or may have different shapes and/or cross-sectional areas. In addition, in an example shown in FIG. 1, the inlet side ventilation pipe 12 and the outlet side ventilation pipe 16 are disposed such that central axes thereof match each other. However, without being limited thereto, the central axis of the inlet side ventilation pipe 12 and the central axis of the outlet side ventilation pipe 16 may be offset from each other.

Sizes (cross-sectional areas or the like) of the inlet side ventilation pipe 12 and the outlet side ventilation pipe 16 may be set as appropriate according to a size of a device in which the ventilation type silencer is used, a required ventilation performance, and the like.

Examples of a material for forming the ventilation pipe include a metal material, a resin material, a reinforced plastic material, and a carbon fiber. Examples of the metal material include metal materials such as aluminum, titanium, magnesium, tungsten, iron, steel, chromium, chromium molybdenum, nichrome molybdenum, and alloys thereof. Examples of the resin material include resin materials such as acrylic resin (PMMA), polymethyl methacrylate, polycarbonate, polyamidimide, polyalylate, polyetherimide, polyacetal, polyetheretherketone, polyphenylene sulfide, polysulfone, polyethylene terephthalate, polybutylene terephthalate (PBT), polyimide, triacetylcellulose (TAC), polypropylene (PP), polyethylene (PE), polystyrene (PS), ABS resin (copolymer synthetic resin of acrylonitrile, butadiene, and styrene), flame-retardant ABS resin, ASA resin (copolymer synthetic resin of acrylonitrile, styrene, and acrylate), polyvinyl chloride (PVC) resin, and polylactic acid (PLA) resin. In addition, examples of the reinforced plastic material include carbon fiber reinforced plastics (CFRP) and glass fiber reinforced plastics (GFRP).

### [Expansion Portion and Housing]

The expansion portion 14 is disposed between the inlet side ventilation pipe 12 and the outlet side ventilation pipe 16 and communicates with the inlet side ventilation pipe 12 and the outlet side ventilation pipe 16.

In a cross section perpendicular to the X-direction, the expansion portion 14 has a larger cross-sectional area than those of both the inlet side ventilation pipe 12 and the outlet side ventilation pipe 16. For example, in a case where the cross-sectional shapes of the inlet side ventilation pipe 12, the outlet side ventilation pipe 16, and the expansion portion 14 are circular, a diameter of the cross section of the expansion portion 14 is larger than diameters of the inlet side ventilation pipe 12 and the outlet side ventilation pipe 16.

The cross-sectional shape of the expansion portion 14 may be various shapes, such as a circular shape, a rectangular shape, and a triangular shape. In addition, the cross-sectional shape of the expansion portion 14 may not be constant in the axial direction (X-direction) of the expansion portion 14. For example, in the X-direction, an equivalent circle diameter of the expansion portion 14 may change. In the example shown in FIG. 1, the cross section of the expansion portion 14 is rectangular, and the cross-sectional shape is constant in the X-direction.

The size (the length, the cross-sectional area, or the like) of the expansion portion 14 may be set as appropriate according to the size of the device in which the ventilation type silencer is used, a required silencing performance, and the like.

The expansion portion 14 has the housing 18 made of a resin, which constitutes an outer edge thereof. The housing 18 has a hollow substantially rectangular parallelepiped shape extending in the X-direction, the inlet side ventilation pipe 12 is connected to one side surface thereof in the X-direction, and the outlet side ventilation pipe 16 is connected to the other side surface thereof facing the one side surface. The central axis of each of the inlet side ventilation pipe 12 and the outlet side ventilation pipe 16 is shifted to one side (lower side in FIG. 1) in a direction (Z-direction) orthogonal to the flow direction (X-direction) with respect to a center of each of these side surfaces.

The housing 18 is made of a resin and is specifically formed of a resin material or a reinforced plastic material. Examples of the resin material include acrylic resin (PMMA), polymethyl methacrylate, polycarbonate, polyamidimide, polyalylate, polyetherimide, polyacetal, polyetheretherketone, polyphenylene sulfide, polysulfone, polyethylene terephthalate, polybutylene terephthalate (PBT), polyimide, triacetylcellulose (TAC), polypropylene (PP), polyethylene (PE), polystyrene (PS), ABS resin (copolymer synthetic resin of acrylonitrile, butadiene, and styrene), flame-retardant ABS resin, ASA resin (copolymer synthetic resin of acrylonitrile, styrene, and acrylate), polyvinyl chloride (PVC) resin, and polylactic acid (PLA) resin. In addition, examples of the reinforced plastic material include carbon fiber reinforced plastics (CFRP) and glass fiber reinforced plastics (GFRP).

The housing 18 has a hollow substantially rectangular parallelepiped shape extending in the X-direction and is composed of six walls as shown in FIGS. 1 and 2. More specifically, the housing 18 has a pair of first walls 18a and 18b (see FIG. 2) disposed at an interval in the Z-direction, a pair of second walls 18c and 18c (see FIG. 2) disposed at an interval in the Y-direction, and a pair of third walls 18d and 18d (see FIG. 1) disposed at an interval in the X-direction. Each of the walls 18a, 18b, 18c, and 18d is a rectangular plate member in plan view. The housing 18 is configured by bonding walls adjacent to each other with an adhesive, a pressure sensitive adhesive, solder, fusion, or the like. Alternatively, in a case where the housing 18 is divided into two parts and fragmented, the housing 18 may be formed by producing each fragment through injection molding, 3D printing, or the like and combining the fragments with each other, or may be integrally formed through blow molding.

Each of the pair of third walls 18d and 18d disposed at an interval in the flow direction (X-direction) is provided with an opening. A joint (also referred to as an adapter) (not shown) for causing the inlet side ventilation pipe 12, the outlet side ventilation pipe 16, and the expansion portion 14 to communicate with each other is attached to the opening. Each of the inlet side ventilation pipe 12 and the outlet side ventilation pipe 16 is attached to an end part of each joint. Accordingly, a gas flowing in the inlet side ventilation pipe 12 is transported to the expansion portion 14 through the inside of one joint, and the gas flowing in the expansion portion 14 is transported to the outlet side ventilation pipe 16 through the inside of the other joint disposed on a side opposite to the one joint.

### [Flow Passage Wall]

As shown in FIG. 2, the flow passage wall 20 is disposed in the housing 18. In a case where a region that causes the inlet side ventilation pipe 12 and the outlet side ventilation pipe 16 to communicate with each other and that linearly links the inlet side ventilation pipe 12 and the outlet side ventilation pipe 16 is defined as a flow passage (also referred to as a flow passage space 24), the flow passage wall 20 is disposed to surround the flow passage space 24. The flow passage wall 20 is formed in a tubular shape of which both ends in the flow direction (X-direction) are open and which extends in the flow direction.

In this example, a cross-sectional shape of the flow passage wall 20, more specifically, a cross-sectional shape perpendicular to the flow direction (X-direction) of a gas flowing in the flow passage wall 20 is a rectangular shape. However, without being limited thereto, the flow passage wall 20 may have various shapes such as a circular shape and a triangular shape.

As shown in FIG. 2, the flow passage wall 20 is disposed on a first wall 18a side (the lower side in FIG. 2) in the Z-direction and is provided at a center of the first wall 18a in the Y-direction.

More specifically, the flow passage wall 20 includes a portion (first portion 18e) of the first wall 18a and is composed of the first portion 18e and three porous sound absorbing materials 21, 22, and 23 as shown in FIG. 2. The flow passage wall 20 is composed of a pair of porous sound absorbing materials 21 and 22, which are disposed at an interval in the Y-direction, and the porous sound absorbing material 23 and the first portion 18e, which are disposed at an interval in the Z-direction. In other words, on the first wall 18a, the pair of porous sound absorbing materials 21 and 22 are disposed on both outsides in the Y-direction with the first portion 18e interposed therebetween. The porous sound absorbing material 23 facing the first portion 18e in the Z-direction is disposed at ends of the porous sound absorbing materials 21 and 22, which is on a side opposite to the first portion 18e in the Z-direction.

As shown in FIG. 2, the first portion 18e defines the flow passage space 24 together with the porous sound absorbing materials 21, 22, and 23. The first portion 18e is positioned at the center of the first wall 18a in the Y-direction and extends from one end (an end on an inlet side ventilation pipe 12 side) to the other end (an end on the outlet side ventilation pipe 16 side) of the first wall 18a in the X-direction. An inside (inner surface) of the first portion 18e faces the flow passage space 24 and is in contact with a gas flowing in the flow passage space 24. For this reason, heat of the gas flowing in the flow passage space 24 is directly transferred to the first portion 18c.

The porous sound absorbing materials 21, 22, and 23 absorb sound by converting sound energy of sound waves passing through the inside into thermal energy. Ends of the three porous sound absorbing materials 21, 22, and 23 in the flow direction (X-direction) are in contact with inner surfaces of the pair of third walls 18d and 18d facing each other in the X-direction. The porous sound absorbing materials 21, 22, and 23 are, for example, rectangular plate members in plan view in which the X-direction is a longitudinal direction.

The porous sound absorbing materials 21, 22, and 23 are not particularly limited, and a known sound absorbing material in the related art can be used as appropriate. For example, various known sound absorbing materials such as a foaming body, a foaming material (foaming urethane foam (for example, CALMFLEX F manufactured by INOAC Corporation, urethane foam manufactured by Hikari Co., Ltd., Everlight manufactured by Archem Inc., Achilles Acron manufactured by Achilles Co., Ltd., and the like), flexible urethane foam, a ceramic particle sintered material, phenol foam, melamine foam, a polyamide foam, and the like), a nonwoven fabric sound absorbing material (a microfiber nonwoven fabric (for example, Thinsulate manufactured by 3M Company and the like), a polyester nonwoven fabric (for example, White Kyuon manufactured by TOKYO Bouon and QonPET manufactured by Bridgestone KBG Co., Ltd. and such products are provided even in the form of a two-layer configuration with a high-density thin surface nonwoven fabric and a low-density rear surface nonwoven fabric), a plastic nonwoven fabric such as an acrylic fiber nonwoven fabric, a natural fiber nonwoven fabric such as wool and felt, a metal nonwoven fabric, a glass nonwoven fabric, and the like), and a material including a minute amount of air (glass wool, rock wool, and a nanofiber-based fiber sound absorbing material (silica nanofiber and acrylic nanofiber (for example, XAI manufactured by Mitsubishi Chemical Corporation))) can be used.

In addition, as the porous sound absorbing materials 21, 22, and 23, a porous sound absorbing material having a two-layer configuration that includes a high-density thin surface nonwoven fabric and a low-density rear surface nonwoven fabric may also be used.

The size, the type, and the like of each of the porous sound absorbing materials 21, 22, and 23 may be set as appropriate according to a silencing performance (a silencing frequency and the amount of silenced sound), the amount of ventilation, and the like required for the ventilation type silencer 10A.

Thicknesses of the porous sound absorbing materials 21, 22, and 23 may be appropriately set to obtain a desired silencing performance according to a flow resistance, porosity, a labyrinth degree, and the like of the porous sound absorbing material 22. For example, from a viewpoint of the silencing performance, the thicknesses of the porous sound absorbing materials 21, 22, and 23 are preferably 3 mm to 50 mm, more preferably 5 mm to 30 mm, and most preferably 10 mm to 20 mm.

### [Rear Space]

As shown in FIG. 2, the rear space 30 is positioned on a side opposite to the flow passage space 24 (hereinafter, also referred to as a rear surface side) with the flow passage wall 20 interposed therebetween. The rear space 30 is a space obtained by excluding the flow passage space 24 from an internal space surrounded by the housing 18, and in a case where the first wall 18a of the housing 18 is directed downward as shown in FIG. 2, a cross-sectional shape thereof has a reverse U-shape in a cross section perpendicular to the X-direction.

The rear space 30 suppresses return of sound waves to the flow passage space 24, which have entered the porous sound absorbing materials 21, 22, and 23 from the flow passage space 24 and which reflect from the housing 18. That is, in a case where the rear surface side of the porous sound absorbing materials 21, 22, and 23 is in direct contact with the housing 18, the sound waves that have entered the porous sound absorbing materials 21, 22, and 23 from the flow passage space 24 reflect from the housing 18 and return to the flow passage space 24. On the other hand, in the ventilation type silencer 10A, as the rear space 30 is provided, a predetermined interval is formed between the porous sound absorbing materials 21, 22, and 23 and the housing 18, so that the reflection of the sound waves from the housing 18 and the return of the sound waves to the flow passage space 24 are suppressed.

The rear space 30 is a space defined by three porous sound absorbing materials 21, 22, and 23 and a second portion of the housing 18, which is different from the first portion 18c. Herein, as shown in FIG. 2, the “second portion” includes a pair of portions 18f and 18f positioned on both outsides in the Y-direction with the first portion 18e of the first wall 18a interposed therebetween and the first wall 18b facing the first wall 18a in the Z-direction. Further, the “second portion” includes the second walls 18c and 18c (see FIG. 2) disposed at an interval in the Y-direction and the third walls 18d and 18d (see FIG. 1) disposed at an interval in the X-direction. That is, the second portion of the housing 18 is composed of the pair of portions 18f and 18f included in the first wall 18a, the first wall 18b, the pair of second walls 18c and 18c, and the pair of third walls 18d and 18d. The second portions 18b, 18c, 18d, and 18f face the rear space 30 and are in contact with a gas in the rear space 30.

From the viewpoint of the silencing performance, a depth of the rear space 30, that is, a distance from one second wall 18c (left side in FIG. 2) to the porous sound absorbing material 21, a distance from the other second wall 18c (right side in FIG. 2) to the porous sound absorbing material 22, and a distance from the first wall 18b (upper side in FIG. 2) to the porous sound absorbing material 23 are preferably 10 mm to 400 mm and more preferably 30 mm to 200 mm. In addition, from the viewpoint of the silencing performance, the depth of the rear space 30 is preferably two to twenty times the thicknesses of the porous sound absorbing materials 21, 22, and 23 and more preferably three to ten times the thicknesses of the porous sound absorbing materials 21, 22, and 23. In addition, the rear space 30 may be filled with the porous sound absorbing material 21, and in this case, a state where the inner surface of the housing 18 and outer surfaces of the porous sound absorbing materials 21, 22, and 23 are in contact with each other is caused.

### [Heat Transfer Member]

The ventilation type silencer 10A shown in FIG. 1 further comprises the heat transfer member 32 that thermally connects the first portion 18e and the second portions 18b, 18c, 18d, and 18f and that have thermal conductivity higher than that of the housing 18. As shown in FIG. 2, the heat transfer member 32 transfers heat, which is transferred to the first portion 18c from a gas flowing in the flow passage space 24, to each of the second portions 18b, 18c, 18d, and 18f.

On an outside of the housing 18, the heat transfer member 32 is disposed along the housing 18. It is preferable that the heat transfer member 32 is configured to entirely cover the outside of the housing 18. However, the heat transfer member 32 does not necessarily need to entirely cover the outside of the housing 18, and it is sufficient for the heat transfer member 32 to thermally connect at least a part of a surface of the first portion 18e and a part of a surface of any one of the second portion 18b, 18c, 18d, or 18f. For example, the heat transfer member 32 may cover the entire surface of the first portion 18e and the entire surfaces of the second portions 18b, 18c, and 18f (excluding the second portion 18d). In addition, the heat transfer member 32 may cover, for example, a part of the surface of the first portion 18e and a part of the surface of the second portion 18b.

The heat transfer member 32 forms, for example, a hexahedron having a hollow substantially rectangular parallelepiped shape that is larger than the housing 18 by one size. More specifically, the heat transfer member 32 is composed of a pair of first heat transfer walls 32a and 32b (see FIG. 2) disposed at an interval in the Z-direction, a pair of second heat transfer walls 32c and 32c (see FIG. 2) disposed at an interval in the Y-direction, and a pair of third heat transfer walls 32d and 32d (see FIG. 1) disposed at an interval in the X-direction. Each of the heat transfer walls 32a, 32b, 32c, and 32d is thermally connected to each of the walls 18a, 18b, 18c, and 18d of the housing 18 positioned inside thereof.

The first heat transfer wall 32a will be described in more detail. As shown in FIG. 2, the first heat transfer wall 32a has a heat transfer portion 32e that is adjacent to the first portion 18e in the Z-direction and that is thermally connected to the first portion 18e and a pair of heat transfer portions 32f and 32f that are adjacent to the pair of portions 18f and 18f in the Z-direction and that are thermally connected to the pair of portions 18f and 18f, respectively. The heat transfer portion 32e is positioned at a center of the first heat transfer wall 32a in the Y-direction and extends from one end (an end on the inlet side ventilation pipe 12 side) to the other end (an end on the outlet side ventilation pipe 16 side) of the first heat transfer wall 32a in the X-direction. The pair of heat transfer portions 32f and 32f are positioned on both outsides in the Y-direction with the heat transfer portion 32e interposed therebetween.

Each of the heat transfer walls 32a, 32b, 32c, and 32d is, for example, a rectangular plate member or sheet in plan view, and a thickness thereof is preferably 3.0 mm or less, more preferably 1.0 mm or less, and most preferably 0.5 mm or less. That is, it is preferable that a thickness of each of the heat transfer walls 32a, 32b, 32c, and 32d is formed to be thin in order to suppress an increase in size of the ventilation type silencer 10A.

Examples of a material for forming the heat transfer member 32 include a material having a thermal conductivity higher than those of a resin material and a reinforced plastic material forming the housing 18. For example, a metal material and carbon fiber are included. Examples of the metal material include metal materials such as aluminum, titanium, magnesium, tungsten, iron, steel, chromium, chromium molybdenum, nichrome molybdenum, and alloys thereof.

A resin material or a reinforced plastic material may be applied as the material for forming the heat transfer member 32 insofar as the thermal conductivity is higher than that of the material for forming the housing 18.

The heat transfer member 32 may be composed of one or a plurality of members insofar as the members are thermally connected. For example, each of the heat transfer walls 32a, 32b, 32c, and 32d may be a different plate member, and the heat transfer member 32 may be configured by thermally connecting end parts of the heat transfer walls 32a, 32b, 32c, and 32d, which are adjacent to each other.

As a unit that thermally connects the heat transfer member 32 to the housing 18, for example, a pressure-sensitive adhesive layer (pressure sensitive adhesive) (not shown) may be applied to a surface of the heat transfer member 32 on a housing 18 side, and more specifically, an inner surface of each of the heat transfer walls 32a, 32b, 32c, and 32d. The heat transfer member 32 is thermally connected to the housing 18 via the pressure-sensitive adhesive layer. The heat transfer member 32 can also be said to be a substrate of a tape having one surface to which the pressure-sensitive adhesive layer is applied. As a material for forming the pressure-sensitive adhesive layer, a material having high thermal conductivity is preferable, and examples thereof include an acrylic pressure-sensitive adhesive material. A thickness of the pressure-sensitive adhesive layer is preferably 0.01 mm to 0.2 mm.

In addition, a pressure-sensitive adhesive layer may be applied to an outer surface of the housing 18, and the heat transfer member 32 may be thermally connected to the housing 18 via the pressure-sensitive adhesive layer. In addition, the heat transfer member 32 may be directly formed on the outer surface of the housing 18 by performing coating or plating treatment on the outer surface of the housing 18 using a material for forming the heat transfer member 32. In addition, in a state where the heat transfer member 32 is in contact with the housing 18, the heat transfer member 32 may be thermally connected to the housing 18 by using a fastener such as a screw.

### Action and Effect

As described above, the ventilation type silencer 10A comprises the heat transfer member 32 that thermally connects the first portion 18e and the second portions 18b, 18c, 18d, and 18f and that have thermal conductivity higher than that of the housing 18, as shown in FIGS. 1 and 2. Accordingly, heat transferred to the first portion 18e from a gas flowing in the flow passage space 24 is transferred to the second portions 18b, 18c, 18d, and 18f via the heat transfer member 32. For this reason, even in a case where the expansion portion 14 composed of the housing 18 made of a resin is installed outdoors and a high-temperature and high-humidity gas having a temperature higher than outdoors flows in the flow passage space, the second portions 18b, 18c, 18d, and 18f of the housing 18 are heated, and cooling of the walls of the housing 18 caused by outside air can be suppressed. Accordingly, even in a case where moisture, which has been transmitted from the flow passage space 24 to the rear space 30 through microholes of the porous sound absorbing materials 21, 22, and 23, comes into contact with the inner surface of the housing 18 in the rear space 30, occurrence of condensation in the rear space 30 is suppressed. Further, as the heat transfer member 32 is provided, it is not necessary to dispose a thick heat insulating member inside or outside the housing 18, and thus an increase in size of the device can be suppressed.

In particular, as the housing 18 is made of a resin, the effect described above is significantly exhibited.

To describe specifically, the housing 18 made of a resin has thermal conductivity lower than that of a housing made of a metal or the like. Therefore, in a case where the ventilation type silencer 10A does not comprise the heat transfer member 32, a large temperature gradient is generated between the first portion 18e, which is in contact with the flow passage space 24, and the second portions 18b, 18c, 18d, and 18f of the housing 18. That is, the first portion 18e in contact with the flow passage space 24 has a high temperature close to a temperature of a gas flowing in the flow passage space 24, and the second portions 18b, 18c, 18d, and 18f have a low temperature close to a temperature of outside air.

As described above, by applying the heat transfer member 32 to the housing 18 having a large temperature gradient, heat is smoothly transferred from a side having a high temperature (first portion 18c) to a side having a low temperature (second portions 18b, 18c, 18d, and 18f). In other words, in a case where the temperature gradient is small, the effect of heat transfer of the heat transfer member 32 is also small.

Therefore, for example, since the thermal conductivity is higher than that of the housing 18 made of a resin, heat is sufficiently transferred from the first portion 18e in contact with the flow passage space 24 to the second portions 18b, 18c, 18d, and 18f even without the heat transfer member 32. For this reason, a temperature gradient is small between the first portion 18e and the second portions 18b, 18c, 18d, and 18f. That is, even in a case where the heat transfer member 32 is applied to the housing made of a metal, the temperature gradient is small, and thus the effect of heat transfer from the side having a high temperature (first portion 18c) to the side having a low temperature (second portions 18b, 18c, 18d, and 18f) is small. As described above, the effect of the heat transfer member 32 is better exhibited as the temperature gradient is larger, and specifically, the effect described above is sufficiently exhibited by the ventilation type silencer 10A comprising the housing 18 made of a resin.

In addition, as shown in FIG. 1 the expansion portion 14 has a larger cross-sectional area than those of both the inlet side ventilation pipe 12 and the outlet side ventilation pipe 16. That is, the ventilation type silencer 10A is a so-called expansion type silencer In such an expansion type silencer, since the size of the housing 18 is large, a distance from the first portion 18e to the second portions 18b, 18c, 18d, and 18f is long. Since the temperature gradient of the housing 18 is larger as the distance is longer, the effect described above is further exhibited by the heat transfer member 32.

In addition, on the outside of the housing 18, the heat transfer member 32 is disposed along the housing 18 as shown in FIG. 2. Accordingly, the heat transfer member 32 is interposed between the housing 18 and outside air, and direct contact of the outside air with the second portions 18b, 18c, 18d, and 18f is suppressed. As a result, occurrence of condensation in the rear space 30 is further suppressed.

In addition, in the usage form in one example of this embodiment, since the temperature of a gas flowing in the flow passage space 24 is higher than a temperature outside the housing 18, the effect of heat transfer in the heat transfer member 32 is further exhibited.

### OTHER EXAMPLES OF EMBODIMENT

Although an example of the ventilation type silencer according to the embodiment of the present invention has been described above, the above embodiment is merely an example for facilitating understanding of the present invention, and the present invention is not limited thereto. That is, the present invention can be changed and improved without departing from the gist thereof. In addition, it is evident that the present invention naturally includes equivalents thereof.

### Modification Example 1

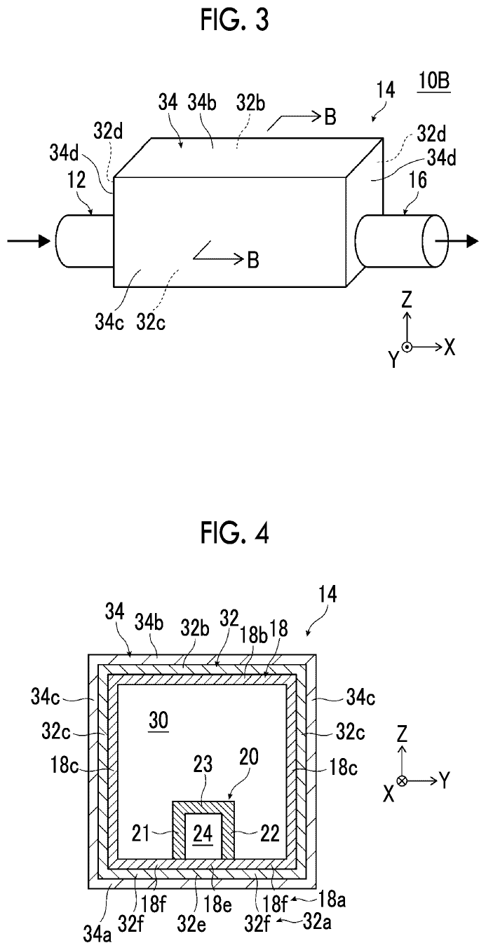

A ventilation type silencer 10B, which is another example of the embodiment of the present invention, will be described with reference to FIGS. 3 and 4. FIG. 3 is a perspective view conceptually showing another example of the ventilation type silencer according to the embodiment of the present invention. FIG. 4 is a cross-sectional view taken along line B-B of FIG. 3.

The ventilation type silencer 10B has a configuration where a heat insulating member 34 is newly added to the ventilation type silencer 10A described above. A configuration other than the heat insulating member 34 is the same as that of the ventilation type silencer 10A.

As shown in FIG. 4, the heat insulating member 34 is disposed along the heat transfer member 32 on an opposite side of the housing 18, that is, the outside of the heat transfer member 32 with the heat transfer member 32 interposed therebetween. The heat insulating member 34 reduces cooling of the housing 18 and the heat transfer member 32 with outside air.

It is preferable that the heat insulating member 34 is configured to entirely cover the outside of the heat transfer member 32. However, the heat insulating member 34 does not necessarily need to entirely cover the outside of the heat transfer member 32 and for example, may cover a part of at least any one of the heat transfer wall 32a, 32b, 32c, or 32d on a side that is particularly cooled by outside air. For example, the heat insulating member 34 may cover the entire surface of each of the heat transfer walls 32a, 32b, and 32c (excluding the heat transfer wall 32d). In addition, the heat insulating member 34 may cover, for example, a part of the surface of the heat transfer wall 32a and a part of the surface of the heat transfer wall 32b.

The heat insulating member 34 forms, for example, a hexahedron having a hollow substantially rectangular parallelepiped shape that is slightly larger than the heat transfer member 32 by one size. More specifically, the heat insulating member 34 is composed of a pair of first heat insulating walls 34a and 34b (see FIG. 4) disposed at an interval in the Z-direction, a pair of second heat insulating wall 34c and 34c (see FIG. 4) disposed at an interval in the Y-direction, and a pair of third heat insulating walls 34d and 34d (see FIG. 3) disposed at an interval in the X-direction. As shown in FIG. 4, each of the heat insulating walls 34a, 34b, 34c, and 34d is in contact with each of the heat transfer walls 32a, 32b, 32c, and 32d positioned inside thereof.

Each of the heat insulating walls 34a, 34b, 34c, and 34d is, for example, a rectangular plate member in plan view, and a thickness thereof is preferably 20 mm or less, more preferably 10 mm or less, and most preferably 5 mm or less. That is, it is preferable that the thickness of each of the heat insulating walls 34a, 34b, 34c, and 34d is formed to be thin in order to suppress an increase in size of the ventilation type silencer 10B.

A material for forming the heat insulating member 34 is not particularly limited, and a known heat insulating member in the related art can be used as appropriate. For example, various known heat insulating members such as a fiber heat insulating member (nonwoven fabric), a foamed heat insulating member (foamed urethane foam), and a micro-through-hole plate (film, sheet) can be used.

The heat insulating member 34 may be composed of one or a plurality of members.

As a unit that attaches the heat insulating member 34 to the heat transfer member 32, for example, a pressure-sensitive adhesive layer (pressure sensitive adhesive) (not shown) may be applied to a surface of the heat insulating member 34 on a heat transfer member 32 side, and more specifically, an inner surface of each of the heat insulating walls 34a, 34b, 34c, and 34d. In this case, the heat insulating member 34 can also be said to be a substrate of a tape having one surface to which the pressure-sensitive adhesive layer is applied. As a material for forming the pressure-sensitive adhesive layer, a material having high thermal conductivity is preferable, and examples thereof include an acrylic pressure-sensitive adhesive material. A thickness of the pressure-sensitive adhesive layer is preferably 0.01 mm to 0.2 mm.

In addition, a pressure-sensitive adhesive layer may be applied to an outer surface of the heat transfer member 32, and the heat insulating member 34 may be attached to the heat transfer member 32 via the pressure-sensitive adhesive layer. In addition, the heat insulating member 34 may be directly formed on the outer surface of the heat transfer member 32 by spraying a material for forming the heat insulating member 34 (for example, a foamed resin) onto the outer surface of the heat transfer member 32. In addition, in a state where the heat insulating member 34 is in contact with the heat transfer member 32, the heat insulating member 34 may be attached to the heat transfer member 32 by using a fastener such as a screw.

As described above, in the ventilation type silencer 10B, as shown in FIG. 4, the heat insulating member 34 is disposed along the heat transfer member 32 on the opposite side of the housing 18 with the heat transfer member 32 interposed therebetween. Accordingly, cooling of the heat transfer member 32 caused by outside air is reduced, and a loss of heat in the process of transferring heat from the first portion 18e to the second portions 18b, 18c, 18d, and 18f is suppressed. That is, in a case where the heat transfer member 32 is in contact with the outside air, the heat transfer member 32 is cooled. For this reason, thermal energy obtained by the first portion 18e from a gas flowing in the flow passage space 24 escapes to the outside of the heat transfer member 32 until the thermal energy reaches the second portions 18b, 18c, 18d, and 18f, and thus a loss of heat occurs. In the ventilation type silencer 10B, by disposing the heat insulating member 34 on the outside of the heat transfer member 32, a loss of the heat can be reduced. As a result, occurrence of condensation in the rear space 30 is further suppressed.

### Modification Example 2

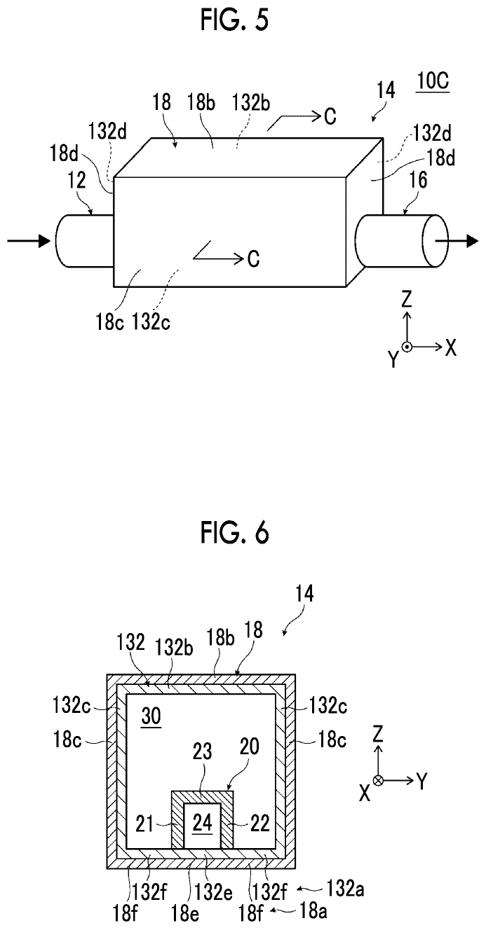

A ventilation type silencer 10C, which is still another example of the embodiment of the present invention, will be described with reference to FIGS. 5 and 6. FIG. 5 is a perspective view conceptually showing still another example of the ventilation type silencer according to the embodiment of the present invention. FIG. 6 is a cross-sectional view taken along line C-C of FIG. 5.

The heat transfer member 32 is disposed on the outside of the housing 18 in the ventilation type silencer 10A shown in FIGS. 1 and 2, but the ventilation type silencer 10C shown in FIGS. 5 and 6 is different in that a heat transfer member 132 is disposed on the inside of the housing 18. Other configurations are the same as those of the ventilation type silencer 10A.

The heat transfer member 132 thermally connects the first portion 18e and the second portions 18b, 18c, 18d, and 18f and has thermal conductivity higher than that of the housing 18.

On the inside of the housing 18, the heat transfer member 132 is disposed along the housing 18. It is preferable that the heat transfer member 132 is configured to entirely cover the inside of the housing 18. However, the heat transfer member 132 does not necessarily need to entirely cover the inside of the housing 18, and it is sufficient that at least a part of the surface of the first portion 18e and a part of the surfaces of the second portions 18b, 18c, 18d, and 18f are thermally connected. For example, the heat transfer member 132 may cover the entire surface of the first portion 18e and the entire surfaces of the second portions 18b, 18c, and 18f (excluding the second portion 18d). In addition, the heat transfer member 132 may cover, for example, a part of the surface of the first portion 18e and a part of the surface of the second portion 18b.

The heat transfer member 132 forms, for example, a hexahedron having a hollow substantially rectangular parallelepiped shape that is smaller than the housing 18 by one size. The heat transfer member 132 is composed of a pair of first heat transfer wall 132a and 132b (see FIG. 6) disposed at an interval in the Z-direction, a pair of second heat transfer wall 132c and 132c (see FIG. 6) disposed at an interval in the Y-direction, and a pair of third heat transfer walls 132d and 132d (see FIG. 5) disposed at an interval in the X-direction. Each of the heat transfer walls 132a, 132b, 132c, and 132d is thermally connected to each of the walls 18a, 18b, 18c, and 18d of the housing 18 positioned outside thereof.

The first heat transfer wall 132a will be described in more detail. As shown in FIG. 6, the first heat transfer wall 132a has a heat transfer portion 132e that is adjacent to the first portion 18e in the Z-direction and that is thermally connected to the first portion 18e and a pair of heat transfer portions 132f and 132f that are adjacent to the pair of portions 18f and 18f in the Z-direction and that are thermally connected to the pair of portions 18f and 18f, respectively. The heat transfer portion 132e is positioned at a center of the first heat transfer wall 132a in the Y-direction and extends from one end (an end on the inlet side ventilation pipe 12 side) to the other end (an end on the outlet side ventilation pipe 16 side) of the first heat transfer wall 132a in the X-direction. The pair of heat transfer portions 132f and 132f are positioned on both outsides in the Y-direction with the heat transfer portion 132e interposed therebetween.

An inside (inner surface) of the heat transfer portion 132e faces the flow passage space 24 and is in contact with a gas flowing in the flow passage space 24. Therefore, heat of the gas flowing in the flow passage space 24 is directly transferred to the heat transfer portion 132c. In a case where the first portion 18e has a region in which the heat transfer portion 132e is not disposed, the heat of the gas flowing in the flow passage space 24 is directly transferred to the region, as in the ventilation type silencer 10A of FIGS. 1 and 2.

In addition, the insides (inner surfaces) of the pair of heat transfer portions 132f and 132f and the heat transfer walls 132b, 132c, and 132d face the rear space 30 and are in contact with a gas in the rear space 30. In a case where the second portions 18b, 18c, 18d, and 18f each have a region in which the pair of heat transfer portions 132f and 132f and the heat transfer walls 132b, 132c, and 132d are not disposed, the region comes into contact with the gas in the rear space 30, as in the ventilation type silencer 10A of FIGS. 1 and 2.

The heat transfer member 132 may be composed of one or a plurality of members insofar as the members are thermally connected. For example, each of the heat transfer walls 132a, 132b, 132c, and 132d may be a different plate member, and the heat transfer member 132 may be configured by thermally connecting end parts of the heat transfer walls 132a, 132b, 132c, and 132d.

Each of the heat transfer walls 132a, 132b, 132c, and 132d is, for example, a rectangular plate member or sheet in plan view, and a thickness thereof is preferably 3.0 mm or less, more preferably 1.0 mm or less, and most preferably 0.5 mm or less. That is, it is preferable that the thicknesses of the heat transfer walls 132a, 132b, 132c, and 132d are formed to be thin in order to suppress a decrease in size of the flow passage space 24 and the rear space 30.

A material for forming the heat transfer member 132 and a unit that thermally connects the heat transfer member 132 to the housing 18 are the same as those in the case of the heat transfer member 32, and description thereof will be omitted.

As described above, in the ventilation type silencer 10C, heat transferred from a gas flowing in the flow passage space 24 to the heat transfer portion 132e is transferred to the housing 18 and the heat transfer member 132 in the rear space 30, and more specifically, the second portions 18b, 18c, 18d, and 18f, the pair of heat transfer portions 132f and 132f, and the heat transfer walls 132b, 132c, and 132d. Accordingly, even in a case where moisture of the rear space 30 has come into contact with the inner surfaces of the housing 18 and the heat transfer member 132 in the rear space 30, occurrence of condensation in the rear space 30 is suppressed.

### Modification Example 3

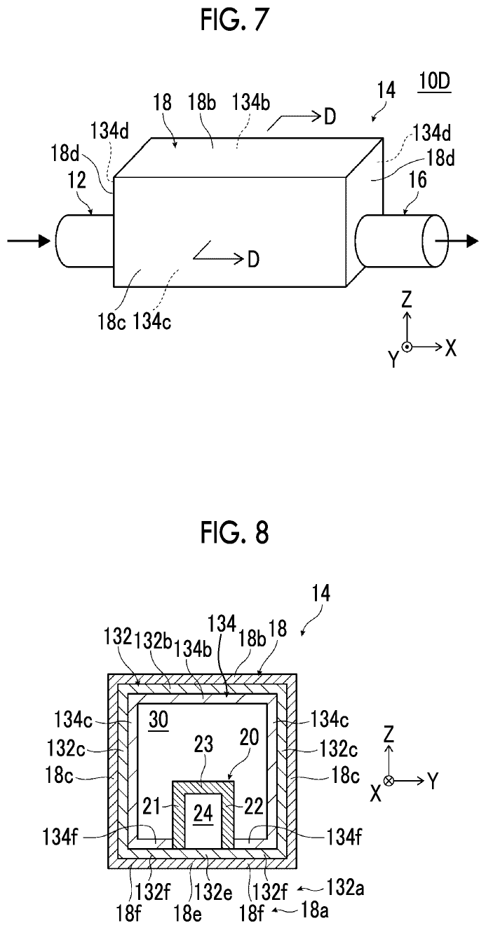

A ventilation type silencer 10D, which is still another example of the embodiment of the present invention, will be described with reference to FIGS. 7 and 8. FIG. 7 is a perspective view conceptually showing still another example of the ventilation type silencer according to the embodiment of the present invention. FIG. 8 is a cross-sectional view taken along line D-D of FIG. 7.

The ventilation type silencer 10D has a configuration where a heat insulating member 134 is newly added to the ventilation type silencer 10C shown in FIGS. 5 and 6. A configuration other than the heat insulating member 134 is the same as that of the ventilation type silencer 10C.

As shown in FIG. 8, the heat insulating member 134 is disposed along the heat transfer member 132 on an opposite side of the housing 18, that is, the inside of the heat transfer member 132 with the heat transfer member 132 interposed therebetween. More specifically, the heat insulating member 134 is disposed along the inside of the heat transfer member 132 in the rear space 30 and is not disposed in the flow passage space 24. That is, an inside (inner surface) of the heat insulating member 134 faces the rear space 30 and is in contact with a gas in the rear space 30. On the other hand, the first portion 18e and the heat transfer portion 132e face the flow passage space 24 and are in contact with a gas flowing in the flow passage space 24, as in the ventilation type silencer 10C of FIGS. 5 and 6. Accordingly, heat of the gas flowing in the flow passage space 24 is appropriately transferred to the first portion 18e and the heat transfer portion 132c.

It is preferable that the heat insulating member 134 is configured to entirely cover the inside of the heat transfer member 132 in the rear space 30. However, in the rear space 30, the heat insulating member 134 does not necessarily need to entirely cover the inside of the heat transfer member 132 and for example, may cover a part of at least any one of the heat transfer wall 132a, 132b, 132c, or 132d on the side that is particularly cooled by outside air. For example, the heat insulating member 134 may cover the entire surface of each of the heat transfer walls 132a, 132b, and 132c (excluding the heat transfer wall 132d). In addition, the heat insulating member 134 may cover, for example, a part of the surface of the heat transfer wall 132a and a part of the surface of the heat transfer wall 132b.

The heat insulating member 134 is composed of a pair of heat insulating portions 134f and 134f (see FIG. 8) disposed on both sides in the Y-direction with the flow passage wall 20 interposed therebetween, a first heat insulating wall 134b (see FIG. 8) disposed at an interval in the Z-direction with respect to the pair of heat insulating portions 134f and 134f, a pair of second heat insulating walls 134c and 134c (see FIG. 8) disposed at an interval in the Y-direction, and a pair of third heat insulating walls 134d and 134d (see FIG. 7) disposed at an interval in the X-direction.

Each of the pair of heat insulating portions 134f and 134f is adjacent to and in contact with each of the pair of heat transfer portions 132f and 132f in the Z-direction. One heat insulating portion 134f (left side in FIG. 8) is positioned on an opposite side of the flow passage space 24 with the porous sound absorbing material 21 interposed therebetween in the Y-direction, and the other heat insulating portion 134f (right side in FIG. 8) is positioned on an opposite side of the flow passage space 24 with the porous sound absorbing material 22 interposed therebetween. The heat insulating portion 134f forms a plate member having a rectangular cross section in which the flow direction (X-direction) is a longitudinal direction.

As shown in FIG. 8, each of the heat insulating walls 134b, 134c, and 134d is in contact with each of the heat transfer walls 132b, 132c, and 132d positioned outside thereof. Each of the heat insulating walls 134b, 134c, and 134d is, for example, a rectangular plate member in plan view.

Thicknesses of the heat insulating portion 134f and the heat insulating walls 134b, 134c, and 134d are preferably 20 mm or less, more preferably 10 mm or less, and most preferably 5 mm or less, and the thicknesses thereof are preferably formed to be thin in order to suppress a decrease in size of the rear space 30.

A material for forming the heat insulating member 134 and a unit that attaches the heat insulating member 134 to the heat transfer member 132 are the same as those in the case of the heat insulating member 34, and description thereof will be omitted.

The heat insulating member 134 may be composed of one or a plurality of members.

As described above, in the ventilation type silencer 10D, as shown in FIG. 8, the heat insulating member 134 is disposed along the inside of the heat transfer member 132 in the rear space 30. Accordingly, cooling of the rear space 30 caused by outside air is reduced, and occurrence of condensation in the rear space 30 is further suppressed. On the other hand, since the inside (inner surface) of the heat transfer portion 132e faces the flow passage space 24, heat of a gas flowing in the flow passage space 24 is appropriately transferred to the heat transfer portion 132e. As a result, the inner surfaces of the housing 18 and the heat transfer member 132 are appropriately heated in the rear space 30.

### Examples

Hereinafter, the present invention will be described in more detail based on examples. Materials, amounts used, ratios, the content of processing, processing procedures, and the like shown in the examples below can be changed as appropriate without departing from the gist of the present invention. Therefore, the scope of the present invention is not to be construed as limiting by the examples shown below.

### Comparative Example

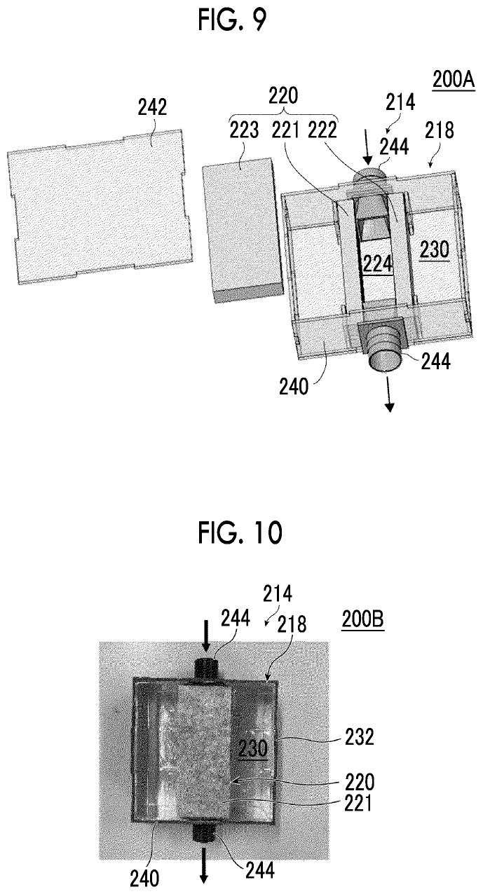

As shown in FIG. 9, a ventilation type silencer 200A according to a comparative example of the present invention is produced. FIG. 9 is an exploded perspective view showing the ventilation type silencer 200A according to the comparative example of the present invention.

A housing 218 constituting an outer edge of an expansion portion 214 is manufactured with six plate members. A hollow rectangular parallelepiped box 240 having one surface open is produced by five plate members, and a lid 242 covering the open one surface (opening) of the box 240 is produced by the remaining one plate member. A thickness of the plate member is set to 3 mm, and a material for forming the plate member is set to an acrylic resin (PMMA). Inner dimensions of the housing 218 are set to a width of 150 mm, a length of 150 mm, and a height of 50 mm.

A pair of joints 244 and 244 are attached to a pair of surfaces of the housing 218 facing each other in the flow direction of a gas, respectively. The joints 244 are produced using a 3D printer. An ABS resin is used as a material for forming the joints 244. On an inner surface of a bottom wall of the box 240, a pair of porous sound absorbing materials 221 and 222 are disposed at an interval with the joints 244 interposed therebetween in a direction orthogonal to the flow direction. A porous sound absorbing material 223 is disposed on upper surfaces of the porous sound absorbing materials 221 and 222. A material for forming the porous sound absorbing materials 221, 222, and 223 is a fiber sound absorbing material (QonPET manufactured by Bridgestone KBG Co., Ltd.), and a thickness of each of the porous sound absorbing materials 221, 222, and 223 is set to 15 mm. Finally, the lid 242 is disposed in an opening of the box 240.

A region surrounded by the porous sound absorbing materials 221, 222, and 223 is a flow passage space 224, and a space on a rear surface side of the porous sound absorbing materials 221, 222, and 223 is a rear space 230.

### Example 1

As shown in FIG. 10, a ventilation type silencer 200B according to example 1 of the present invention is produced. FIG. 10 is a view showing an image of the ventilation type silencer 200B according to example 1 of the present invention, which is captured by a camera. In the ventilation type silencer 200B, the only difference from the ventilation type silencer 200A according to the comparative example shown in FIG. 9 is that a heat transfer member 232 is newly disposed along the outside of the housing 218. A heat transfer sheet (heat transfer tape), in which the heat transfer member 232 is used as a substrate and a pressure-sensitive adhesive layer is applied to one surface of the substrate, is pasted along the outside of the housing 218. The substrate (heat transfer member 232) has a thickness of 100 μm, and a material for forming thereof is aluminum.

### Example 2

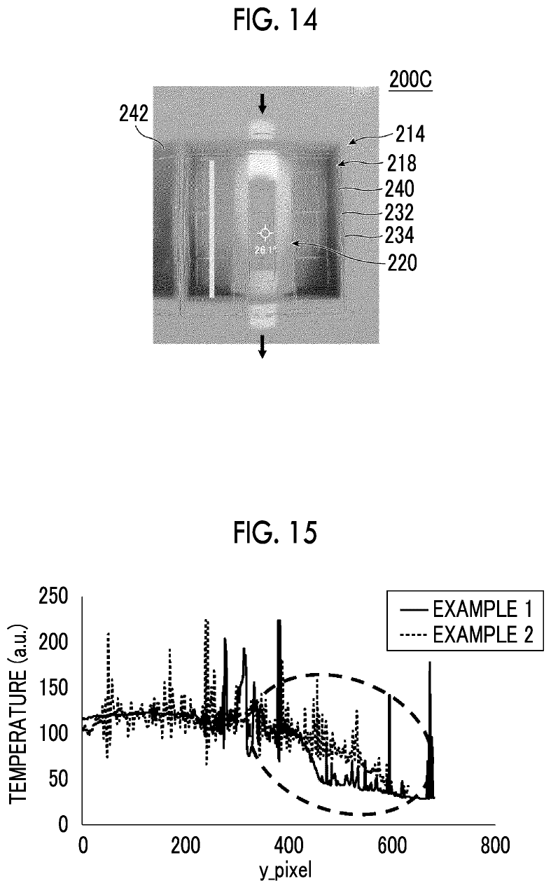

A ventilation type silencer 200C according to example 2 of the present invention is produced (see FIG. 14). In the ventilation type silencer 200C, the only difference from the ventilation type silencer 200B according to example 1 shown in FIG. 10 is that a heat insulating member 234 is newly disposed along the outside of the heat transfer member 232. A heat insulating sheet (heat insulating tape), in which the heat insulating member 234 is used as a substrate and a pressure-sensitive adhesive layer is applied to one surface of the substrate, is pasted along the heat transfer member 232. The substrate (heat insulating member 234) has a thickness of 3 mm, and Acroflex manufactured by Nissho-Acrospace Co., Ltd. is used as a material for forming the substrate.

### [Evaluation]

### (Temperature Distribution in Expansion Portion)

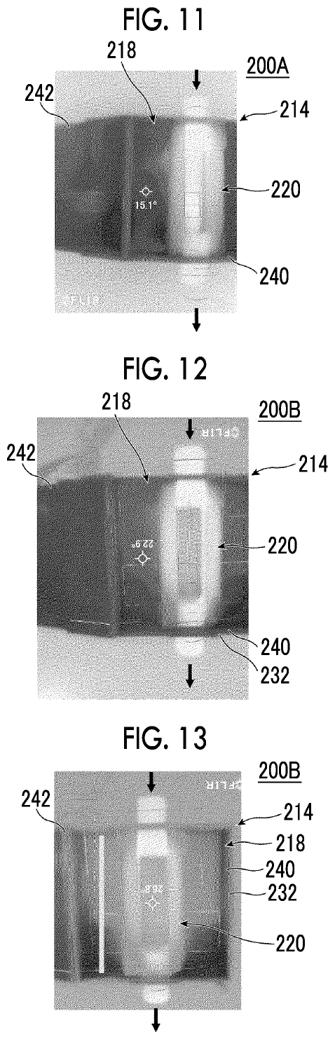

As shown in FIGS. 11 to 15, a temperature distribution of the housing 218 is measured for each of the produced ventilation type silencers. FIG. 11 is a view showing an image of the ventilation type silencer 200A according to the comparative example, which is captured by an infrared thermography camera. FIGS. 12 and 13 are views showing images of the ventilation type silencer 200B according to example 1, which are captured by the infrared thermography camera. FIG. 14 is a view showing an image of the ventilation type silencer 200C according to example 2, which is captured by the infrared thermography camera. FIG. 15 is a graph comparing temperature distributions in the housing in examples 1 and 2.

As a measuring method, first, the expansion portion 214 is disposed in a box of which an internal space is cooled to 10° C., and the expansion portion 214 is left such that a temperature of the expansion portion 214 becomes similar to a temperature in the box. After then, a hose is connected to each of the pair of joints 244, and air at 30° C. and 36% RH is flowed into the expansion portion 214 for 30 minutes. After 30 minutes, passage of air is stopped, the lid 242 of the housing 218 is opened, and a temperature inside the housing 218 is imaged with the infrared thermography camera.

As a result of the evaluation, in the ventilation type silencer 200A according to the comparative example, as shown in FIG. 11, it can be seen that a temperature of a portion of the housing 218 at an edge part of a flow passage wall 220 has risen. However, it is found that a temperature of a portion of the housing 218 away from the flow passage wall 220 has not risen.

On the other hand, in the ventilation type silencer 200B according to example 1, as shown in FIG. 12, it can be seen that the temperature of the portion of the housing 218 away from the flow passage wall 220 has risen.

Specifically, as shown in FIGS. 11 and 12, a temperature of an inner surface of a bottom wall of the housing 218 is observed at a fixed point at a position (a position on the left side of the flow passage wall 220 in FIGS. 11 and 12) away from the flow passage wall 220 in the direction orthogonal to the flow direction of air. As a result, at the position of observation at the fixed point, comparative example shows 15.1° C., and example 1 shows 22.9° C. That is, it is found that the temperature has risen by 7.8° C. in example 1 compared to comparative example.

In addition, in the ventilation type silencer 200C according to example 2, it is found that the temperature of the portion of the housing 218 away from the flow passage wall 220 has further risen compared to the ventilation type silencer 200B.

Specifically, as shown in FIGS. 13 and 14, an imaginary line parallel to the flow direction of air is drawn from an upstream end to a downstream end of the bottom wall of the housing 218 and temperature distributions of examples 1 and 2 are compared for the line at a position (a position on the left side of the flow passage wall 220 in FIGS. 13 and 14) away from the flow passage wall 220 in the direction orthogonal to the flow direction of air.

The results are shown in FIG. 15. A horizontal axis of FIG. 15 indicates a distance from the upstream end of the bottom wall of the housing 218 with the upstream end as 0 in the imaginary line described above, and a vertical axis of FIG. 15 indicates a temperature of the inner surface of the bottom wall.

As shown in FIG. 15, there is no difference on an upstream side of the housing 218 in the temperature of the inner surface of the bottom wall of examples 1 and 2, but the temperature of example 2 is higher than that of example 1 on a downstream side of the housing 218.

### (Transmission Loss)

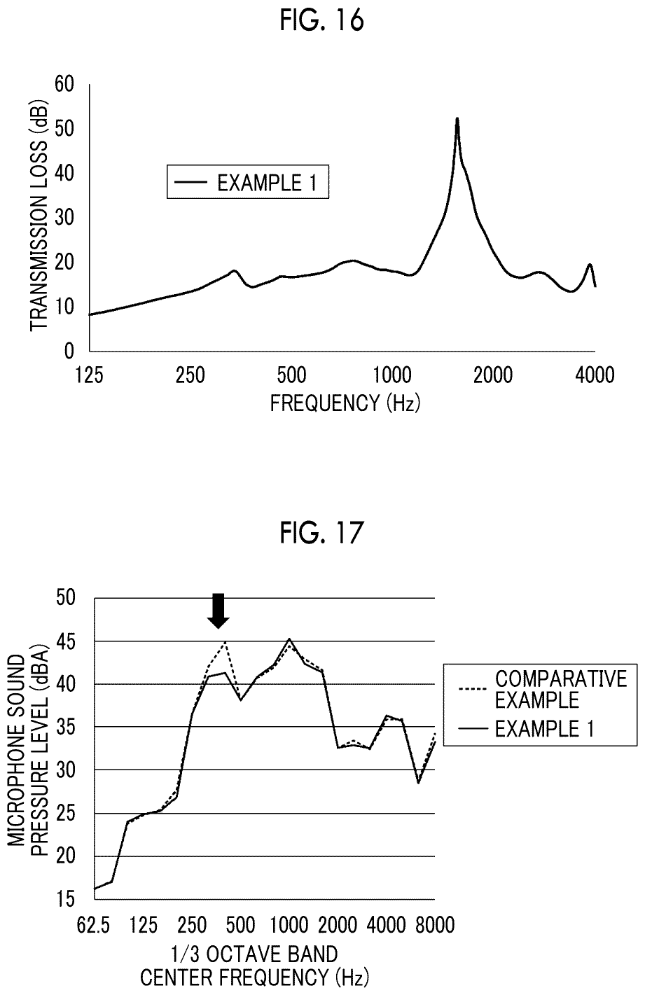

As shown in FIG. 16, a transmission loss of the produced ventilation type silencer 200B of example 1 is measured. Four-terminal method measurement using an acoustic tube is performed as the measurement therefor. In the graph of FIG. 16, a horizontal axis indicates a frequency, and a vertical axis represents a transmission loss. As a result of the evaluation, it is found that the ventilation type silencer 200B of example 1 has a band of a resonance frequency near 1,800 Hz.

### (Noise)

As shown in FIG. 17, noise released from the ventilation type silencer to the outside is measured for each of comparative example and example 1. In the graph of FIG. 17, a horizontal axis indicates a ⅓ octave band center frequency, and a vertical axis indicates a microphone sound pressure level.

As a measurement method, a microphone for measurement is installed at a position separated away from the housing 218 above the housing 218, and a sound pressure level of the microphone in a case where white noise is input to the flow passage space 224 is measured.

As a result of the evaluation, it is found that, in example 1, the microphone sound pressure level in the vicinity of 400 Hz is reduced compared to comparative example. That is, it is found that the noise (400 Hz) generated by oscillation of a wall of the housing 218 can be improved by the heat transfer member 232.

From the results, effects of the present invention are clear.

### EXPLANATION OF REFERENCES

10A, 10B, 10C, 10D, 200A, 200B, 200C: ventilation type silencer
12: inlet side ventilation pipe
14, 214: expansion portion
16: outlet side ventilation pipe
18, 218: housing
18a: first wall
18b: first wall (second portion)
18c: second wall (second portion)
18d: third wall (second portion)
18e: first portion
18f: portion (second portion)
20, 220: flow passage wall
21, 22, 23, 221, 222, 223: porous sound absorbing material
24, 224: flow passage space
30, 230: rear space
32, 132, 232: heat transfer member
32a, 32b, 132a, 132b: first heat transfer wall
32c, 132c: second heat transfer wall
32d, 132d: third heat transfer wall
32e, 32f, 132e, 132f: heat transfer portion
34, 134, 234: heat insulating member
34a, 34b, 134b: first heat insulating wall
34c, 134c: second heat insulating wall
34d, 134d: third heat insulating wall
134f: heat insulating portion
240: box
242: lid
244: joint

What is claimed is:

1. A ventilation type silencer comprising:
an inlet side ventilation pipe;
an expansion portion that communicates with the inlet side ventilation pipe and that has a cross-sectional area larger than a cross-sectional area of the inlet side ventilation pipe;
an outlet side ventilation pipe that communicates with the expansion portion and that has a cross-sectional area smaller than the cross-sectional area of the expansion portion;
a housing that constitutes the expansion portion and that is made of a resin;
a flow passage wall that is disposed in the housing, that causes the inlet side ventilation pipe and the outlet side ventilation pipe to communicate with each other, and that is composed of a first portion of the housing and a porous sound absorbing material;
a rear space that is positioned on an opposite side of a flow passage space in the flow passage wall with the porous sound absorbing material interposed therebetween and that is defined by the porous sound absorbing material and a second portion different from the first portion of the housing; and
a heat transfer member that thermally connects the first portion and the second portion and that has thermal conductivity higher than thermal conductivity of the housing.

2. The ventilation type silencer according to claim 1,
wherein on an outside of the housing, the heat transfer member is disposed along the housing.

3. The ventilation type silencer according to claim 1,
wherein on an inside of the housing, the heat transfer member is disposed along the housing.

4. The ventilation type silencer according to claim 3, further comprising:
a heat insulating member that is disposed along an inside of the heat transfer member in the rear space.

5. The ventilation type silencer according to claim 2, further comprising:
a heat insulating member that is disposed along the heat transfer member on an opposite side of the housing with the heat transfer member interposed therebetween.

6. The ventilation type silencer according to claim 1,
wherein a temperature of a gas flowing in the flow passage space is higher than a temperature outside the housing.

7. The ventilation type silencer according to claim 2,
wherein a temperature of a gas flowing in the flow passage space is higher than a temperature outside the housing.

8. The ventilation type silencer according to claim 3,
wherein a temperature of a gas flowing in the flow passage space is higher than a temperature outside the housing.

9. The ventilation type silencer according to claim 4,
wherein a temperature of a gas flowing in the flow passage space is higher than a temperature outside the housing.

10. The ventilation type silencer according to claim 5,
wherein a temperature of a gas flowing in the flow passage space is higher than a temperature outside the housing.
